(19) United States
(12) Patent Application Publication
(10) Pub. No.: US 2004/0074847 A1
(43) Pub. Date: Apr. 22, 2004

(54) Stable N-bromo-2-pyrrolidone and methods to make the same

(76) Inventor: Percy A. Jaquess, Friendship, TN (US)

Correspondence Address: KILYK & BOWERSOX, P.L.L.C., 53 A EAST LEE STREET, WARRENTON, VA, 20186, US

(21) Appl. No.: 10/272,390

(22) Filed: Oct. 16, 2002

(51) Int. Cl. C02F 1/68

(52) U.S. Cl. 210/764

(57) ABSTRACT

A biocidal composition is provided and includes stable N-bromo-2-pyrrolidone. A composition is also provided and includes reacting hypobromous acid with 2-pyrrolidone. Biocidal uses are also described.

### BACKGROUND OF THE INVENTION

The present invention relates to a composition and method of treating aqueous systems and/or process water to inhibit growth of microorganisms. More particularly, the present invention relates to a stable N-bromo-2-pyrrolidone. A number of chemicals have been used in industrial and recreational water systems to control biofouling. Currently, sodium hypochlorite and bromine solutions are used in a variety of industrial and recreational water systems to control biofouling. However, sodium hypochlorite is unstable and must be provided in a stabilized form There are several methods known in the art for stabilizing a hypochlorite (see, e.g. U.S. Pat. Nos. 3,328,294 and 3,767,586).

Bromine is preferred over chlorine for use in water treatment because of its lower volatility and better performance in higher pH and amine environments. However, like sodium hypochlorite, sodium hypobromite is unstable in typical storage conditions and therefore must also be provided in a stabilized form U.S. Pat. Nos. 6,270,722, 5,683,654, and 5,795,487 show that sodium hypobromite solution can be stabilized with a solution of sulfamic acid, water, and sodium hydroxide. These references and others teach that the stabilizer may be selected from saccharine, urea, thiourea, creatinine, cyanuric acid, alkyl hydantoins, mono and diethanolamine, organic sulfonamides, organic sulfamates, melamine, and preferably sulfamic acid.

Other references indicate that halophor biocidal compositions, e.g., bromophors, having N-alkyl substituted-2-pyrrolidone, e.g., N-methyl pyrrolidone and an iodine with cross-linked N-vinyl lactams, e.g., N-vinyl-2-pyrrolidone polymers, are produced for biocide use. However, these N-alkyl substituted pyrrolidones and iodine complexed N-vinyl lactams are produced as water-insoluble moieties.

Other references utilize aqueous solutions containing an iodine-complex polymer, e.g., polyvinylpyrrolidone-iodine (known as providone-iodine). These iodine molecules, which are included in or associated with macromolecules of polyvinylpyrrolidone, are in the form of a mixture and are not bonded

Accordingly, there is a need to overcome one or more of the above-described disadvantages.

### SUMMARY OF THE PRESENT INVENTION

A feature of the present invention is to provide a strong biocidal composition, which is significantly more stable than hypobromous acid.

Another feature of the present invention is to provide a strong biocidal composition that is stable for months and can be added to an aqueous system and/or processed water as a single-line feeding biocidal program to inhibit microorganisms.

Another feature of the present invention is to provide a composition that has a high biocidal activity under alkaline conditions in high chlorine demand systems.

A further feature of the present invention is to provide a composition that does not generate toxic chlorine byproducts, such as chloroform, which is a potential carcinogen.

A further feature of the present invention is to provide a composition that is a clear, colorless, liquid concentrate, which does not tint or color process water equipment or materials.

Another feature of the present invention is to provide a composition that controls the growth of living organisms, such as microorganisms in pulp and paper processes.

A further feature of the present invention is to provide a composition that prevents biofouling in recirculating cooling water systems.

A further feature of the present invention is to provide a composition that disinfects swimming pools or water sources.

A further feature of the present invention is to provide a composition that sanitizes and disinfects hard surfaces such as for food processing plants, breweries, and hospitals.

Another feature of the present invention is to provide a disinfection composition for drinking water

A further feature of the present invention is to provide a composition that prevents biofouling, for instance, of reverse osmosis membranes or other devices.

A further feature of the present invention is to provide a composition that can be used as a sanitizer/disinfectant, such as for agricultural equipment.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages and in accordance with the purposes of the present invention, as embodied and broadly described herein, the present invention relates to N-bromo-2-pyrrolidone in an aqueous solution. The present invention also relates to a method of making stable N-bromo-2-pyrrolidone comprising reacting hypobromous acid with 2-pyrrolidone.

The present invention also relates to uses of the N-bromo-2-pyrrolidone.

It is to be understood that both the foregoing general description and the following detailed description are exemplary and explanatory only and are intended to provide a further explanation of the present invention as claimed.

### DETAILED DESCRIPTION OF THE PRESENT INVENTION

The present invention relates to a stable biocidal composition and a method of making the biocidal composition. In general, the present invention relates to N-bromo-2-pyrrolidone in an aqueous solution. The present invention further relates to the product formed by the reaction of a hypobromous acid with a 2-pyrrolidone.

The N-bromo-2-pyrrolidone of the present invention is preferably capable of remaining stable in an aqueous solution for a long period of time and can be added to an aqueous system and/or process water as a single line feeding biocidal program to inhibit or control microorganisms. It is to be understood that by “controlling” (i.e., preventing) the growth of at least one of microorganism, the growth of the microorganism is inhibited. In other words, there is essentially no growth of the microorganism. “Controlling” or “inhibiting” the growth of at least one microorganism maintains the microorganism population at a desired level, and/or reduces the population to a desired level (even to undetectable limits, e.g., zero population) Thus, in one embodiment of the present invention, the products, material, or media susceptible to attack by at least one microorganism are preserved from this attack and from the resulting spoilage and other detrimental effects caused by the microorganism. Further, it is also to be understood that “controlling” or “inhibiting” the growth of at least one microorganism also includes biostatically reducing and/or maintaining a low level of at least one microorganism such that the attack by the microorganism and any resulting spoilage or fouling, or other detrimental effects are mitigated, i.e., the microorganism growth rate or microorganism attack rate is slowed down and/or eliminated.

Preferably, the N-bromo-2-pyrrolidone of the present invention is stable in an aqueous solution for at least one day. Preferably, the N-bromo-2-pyrrolidone of the present invention is stable in an aqueous solution for at least one week. More preferably, the N-bromo-2-pyrrolidone of the present invention is stable in an aqueous solution for at least one month. Even more preferably, the N-bromo-2-pyrrolidone of the present invention is stable in an aqueous solution for at least six months. Most preferably, the N-bromo-2-pyrrolidone of the present invention is stable in an aqueous solution for at least one year.

Preferably, the N-bromo-2-pyrrolidone of the present invention is fully soluble in an aqueous solution without losing its biocidal activity.

Other compositions or materials such as hypobromous acid may also be present in the aqueous solution along with the N-bromo-2-pyrrolidone. Other active ingredients or inert ingredients conventional to microbiocidal control can be used with the present invention in the same solution or by separate applications.

Unlike previous N-bromo-2-pyrrolidone which is not stable in aqueous solutions and furthermore is only stable in the solid crystalline form when synthesized with bromine and chloroform in the absence of water, the present invention provides a stable N-bromo2-pyrrolidone which is stable in aqueous solutions and provides excellent biocidal efficacy. Unlike the present invention, halophor biocidal compositions such as bromophors containing a complex of N-alkyl substituted-2-pyrrolidone, e.g., Nmethylpyrrolidone and complexes of iodine with cross-linked N-vinyl lactams such as N-alkylvinyl-2-pyrrolidone polymers are produced for biocide use. However, these N-alkyl substituted pyrrolidones and iodine complexed N-vinyl lactams are produced as water insoluble moieties. In the present invention, when the N-bromo-2-pyrrolidone is formed in the present invention and applied to these N-alkyl substituted pyrrolidones and to cross-linked N-vinyl lactams, the reactions do not produce moieties with any biocidal efficacy. Previously, reactions of sodium hypochloride and sodium bromide produced an unstable sodium hypobromide solution which is then stabilized with a critical order of addition of a solution of sulfamic acid, water, and sodium hydroxide. Furthermore, stabilizers were sometimes used such as saccharin, urea, thiourea, creatinine, cyanuric acid, alkylhydantonis, mono and diethanol amine, organic sulfonamides, organic sulfamates, melamine, and sulfamic acid. However, in the present invention, no stabilizers are needed to stabilize the sodium hypobromide which is preferably used to form the N-bromo-2-pyrrolidone. In addition, other aqueous solutions contain an iodine-complex polymer, such as a polyvinylpyrrolidone-iodine (known as providone-iodine), wherein the iodine molecules are included in or associated with macromolecules of polyvinylpyrrolidone as a mixture. Unlike this, in the present invention, the bromine is preferably covalently bonded to the 2-pyrrolidone molecule which is not a polymer halide mixture.

Thus, the present invention preferably provides higher biocidal activity under alkaline conditions in high chlorine demand systems and preferably does not generate toxic chlorine byproducts such as chloroform which is a potential carcinogen.

The preferred method of making the N-bromo-2-pyrrolidone is by reacting hypobromous acid, preferably in an aqueous solution, with 2-pyrrolidone to form the stable N-bromo-2-pyrrolidone of the present invention in an aqueous solution. Preferably, the hypobromous acid in aqueous solution is formed by reacting sodium hypochlorite with sodium bromide or other alkali metal hypochlorites and bromides.

Other derivatives of pyrrolidone, such as alkyl-substituted pyrrolidone and tri-pyrrolidone complexes can be used to make a composition, such as N-bromo-alkyl-substituted 2-pyrrolidone. The 2-pyrrolidone of the present invention is commercially available. Any purity of 2-pyrrolidone can be used Preferably, the 2-pyrrolidone is at least about 90% pure. Preferably, the concentration of the 2-pyrrolidone is from about 90 wt. percent to about 98 wt. percent and more preferably, is from about 98 wt. percent to about 99+wt. percent.

Hypobromous acid is not typically stable, and can ionize within minutes, thus it is preferable to prepare the hypobromous acid as needed. In one example, the hypobromous acid forms from a reaction of at least one oxidizing agent with at least one bromide source. Other reaction mechanisms can also be used to produce a hypobromous acid.

The starting oxidizing agent used to prepare the hypobromous acid is preferably sodium hypochlorite because it generates clean hypobromous acid. Other semi-metals may also be used. The concentration of the oxidizing agent (e g. sodium hypochlorite) can range from about 2 wt. % to about 30 wt. %. Generally, the oxidizing agent is commercially available from about 10 wt. % to concentrations of as high as about 15 wt %. Higher concentrations (more than 15 wt %) can also be used; however, at higher than 15 wt. % concentration, the sodium hypochlorite generally is placed in a pressurized container. High punty sodium hypochlorite is not essential. If used, it is preferred to use sodium hypochlorite that has a concentration of from about 15 to about 30 wt. percent.

The starting bromide source used to prepare the hypobromous acid can be any source of bromide such as Br₂. Preferably, the source of bromide is sodium bromide. Preferably, the bromide source is coarse and granular. Any concentration of the bromide source can be used. For example, a concentration of from about 20 wt. percent to about 60 wt. percent bromide source can be used About 40 wt. % bromide source (e.g. sodium bromide) is preferably used because it can ideally react with a concentration of from about 13 wt % to about 15 wt. % of an oxidizing agent.

Preferably, the bromide source is an aqueous bromide source. Preferably, the bromide source is dissolved in enough aqueous solvent to make from about 20 wt. % to about 60 wt % aqueous bromide source solution More preferably, the sodium bromide can be dissolved in enough solvent to make about 40 wt. % aqueous sodium bromide solution. Preferably, the sodium bromide is dissolved in water. Preferably, the bromide source is diluted in water in a bromide source-to-water wt. ratio of from about 1:5 to about 3:5. More preferably, the weight ratio of water to sodium bromide is about 2.5:1, though other ratios can be readily used.

The oxidizing agent is the controlling agent. Thus, the concentration of the oxidizing agent preferably determines the concentration of the bromide source, which in turn can determine the concentration of the hypobromous acid produced Preferably, the oxidizing agent, such as sodium hypochlorite, can be diluted in an aqueous solvent, preferably water, to produce the desired concentration of the oxidizing agent. Preferably, the ratio of the oxidizing agent, such as sodium hypochlorite to water, can be from about 1:7.5 to about 1:3.5. Other ratios can be used.

The aqueous solvent, preferably water, that is used to dilute the oxidizing agent, the bromide source, and the 2-pyrrolidone can have a pH range of from about 4 to about 8, and more preferably from about 5.5 to about 6.8. The water used as the solvent can be any type of water, such as tap water or DI water. Acidic water is not preferred when preparing the 2-pyrrolidone because acidic water can affect the 2-pyrrolidone, since the 2-pyrrolidone acts as a base and has basic characteristics.

One method of making the biocidal composition of the present invention is by reacting a hypobromous acid with a 2-pyrrolidone.

In order to prepare the 2-pyrrolidone to be reacted with the hypobromous acid, it is preferred to dilute the 2-pyrrolidone in an aqueous solvent, preferably water Preferrably, the ratio of the 2-pyrrolidone to water is from about 1.100 to about 100:1 and more preferably is from about 10:1 to about 1:10. There are at least two reasons for diluting the 2-pyrrolidone in water. First, 100% 2-pyrrolidone can run a hot and violent reaction. Thus, diluting the 2-pyrrolidone in water can reduce the intensity of the reaction. Second, the concentration of N-bromo-2-pyrrolidone depends on the concentration of hypobromous acid and not the concentration of the 2-pyrrolidone. Thus, having 100% pyrrolidone does not improve the concentration of N-bromo-2-pyrrolidone.

The 2-pyrrolidone and hypobromous acid can be added together in any fashion. Preferably, the 2-pyrrolidone is added to the hypobromous acid over a period of about 20 minutes to about 60 minutes, and more preferably over a period of about 10 minutes to about 40 minutes, and most preferably, over a period of about 15 to about 20 minutes, at a rate of from about 100 L/min. to about 10 L/min., preferably at a rate of from about 50 L/min over about 15 to about 30 minutes. Preferably, the ratio of the 2-pyrrolidone to the hypobromous acid is approximately 1:1, more preferably, the ratio is about 2 1. Extra amounts of the 2-pyrrolidone can be used to make sure that the reaction is completed. Thus, the ratio of the hypobromous acid to the 2-pyrrolidone is preferably about 1:1, and more preferably, is about 2:1 This ensures that there is enough of the 2-pyrrolidone available to react with all of the hypobromous acid

The reaction between hypobromous acid and 2-pyrrolidone is an exothermic reaction. Preferably, the reaction is cooled because excess heat can initiate reversal and/or inhibition of the reaction. Preferably, the reaction is cooled so that the temperature does not exceed about 100° C. More preferably, the reaction is cooled to about 60° C., and most preferably the temperature of the reaction is controlled so that it does not exceed about 55° C.

One way to determine whether the reaction between the hypobromous acid and the 2-pyrrolidone has been completed is by the color change of the solution Due to the characteristics of the reaction, the reaction changes color from amber/yellow to clear. Another way to determine whether the reaction between the hypobromous acid and the 2-pyrrolidone is completed is by testing the pH level of the solution. When the pH of the solution reaches about 7 5 to about 9 5, and more preferably from about 8 to about 9, all of the hypobromous acid has been converted to a stable N-bromo-2-pyrrolidone.

As set forth above, the yields of the final product typically range from about 5 to about 15 wt. % depending on the reaction, the purity, the concentration of the starting materials, and the like. The method of producing the compound of the present invention, as set forth above, is not meant to be exclusive or limiting, but rather is exemplary only, and other means for generating stable N-bromo-2-pyrrolidone are possible. One such method of making N-bromo2-pyrrolidone is by reacting 2-pyrrolidone with bromine (BR2) in the presence of water and dipropylene glycol. Here dipropylene glycol acts as a catalyst.

One exemplary method of making the hypobromous acid of the present invention is by introducing an oxidizing agent, such as sodium hypochlorite, to a bromide source, such as 40% aqueous sodium bromide. The 2-pyrrolidone, preferably diluted 2-pyrrolidone, can then be introduced to the hypobromous acid to produce the final product of N-bromo-2-pyrrolidone.

The concentration of the hypobromous acid depends on the concentration of the initial reactant agents, and more specifically depends on the amount of oxidizing agent used in the reaction. Preferably, at least about 2% sodium hypochlorite is used in this method of making stable N-bromo-2-pyrrolidone. Thus, the concentration of the oxidizing agent determines the concentration of the bromide source that can be used. Preferably, the ratio of the sodium hypochloride to the sodium bromide is about 1:4 to about 1:2.

The rate of generating the hypobromous acid can be controlled so that a complete reaction takes place to make the maximum amount of hypobromous acid. The rate of generating the hypobromous acid is controlled by the amount of the bromide source added to the reactor that contains the oxidizing agent. Preferably, the concentration of the oxidizing agent determines the concentration of the hypobromous acid, and preferably the rate of generating the hypobromous acid is controlled by the amount of bromide source added to the reactor. Preferably, the ratio of the bromide source to the oxidizing agent can range from about 2:1 to about 4:1 and more preferably from about 2.5:1 to about 3.2:1. Because the addition of the bromide source produces a slightly exothermic reaction, it is preferable to add the bromide source slowly to the reactor containing the oxidizing agent, such as sodium hypochlorite. Preferably, the bromide source can be added to the reactor containing the oxidizing agent under moderate agitation (100 rpm, but not over 250 rpm) at a rate of from about 200 L/min. to about 100 L/min. By slowly adding the bromide source to the reactor containing oxidizing agent, a moderate generation rate of hypobromous acid can be achieved. The preferred rate of generating the hypobromous acid is in a range of from about 0.0907 moles/liter/min. (mol/l/min.) or more to about 0.0226 mol/lmin. or less, preferably from about 0.0604 to about 0.0302 mol/l/min., and most preferably from about 0.0453 to about 0 0362 mol/lmin.

The reaction time for the oxidizing agent, such as sodium hypochlorite, and the bromide source, such as sodium bromide, is from about 10 minutes to about 40 minutes.

Preferably, the reaction time between the sodium hypochlorite and the sodium bromide is from about 20 to about 25 minutes.

There are at least two ways to determine whether the reaction between the oxidizing agent and the bromide source is complete. First, the completion of the reaction can be determined by the color change of the solution in the reactor More preferably, the completion of the reaction can be determined by the pH level of the solution. The pH level of approximately 8.5 to 9.5 determines the presence of hypobromous acid in the reactor. Because sodium hydroxide and salt are also formed, the pH can flux from about 8.5 and 9.5 until the reaction reaches an equilibrium The pH can then fall below 8 and more preferably the pH can fall to a neutral level. More preferably, the acid has a pH below 7. Most preferably, the acid is hypobromous acid, which has a pH of greater or equal to 4 To maintain the hypobromous acid status, the pH can range from about 4 to about 8. This pH level gives limited dissociation of the hypobromous acid. As stated above, the 2-pyrrolidone can then be added to the hypobromous acid.

As stated earlier, the compound of the present invention is an effective biocidal composition that is significantly more stable than hypobromous acid. More specifically, the compound of the present invention can be stable for at least one day. Preferably, the compound of the present invention is stable for at least one week, more preferably for at least one month, or for at least six months, and most preferably for at least one year. Additionally, the compound of the present invention can be used in the treatment of aqueous systems and/or processed water as a single-line feeding biocidal program to inhibit microorganisms.

It is interesting to note that when the reaction process of the present invention is applied to forming N-alkyl substituted pyrrolidones and/or cross-linked N-vinyl-lactams, the reaction does not produce a compound with any biocidal efficacy. The compound of the present invention also has a high biocidal activity under alkaline conditions in high-chlorine demand systems. Furthermore, the biocidal composition of the present invention does not generate toxic chlorine byproducts, such as chloroform, which is a potential carcinogen.

The compound of the present invention can provide a composition that is a clear, colorless, and a liquid concentrate which will not tint or color process water equipment or material that controls the growth of living organisms in pulp and paper processes. Additionally, the compound of the present invention can prevent biofouling in recirculating cooling water systems, and disinfects swimming pools.

In addition, the compound of the present invention can sanitize and disinfect hard surfaces for food processing plants, breweries, and hospitals. Moreover, the compound of the present invention can disinfect drinking water and prevent biofouling of reverse osmosis membranes and other systems Furthermore, it can be used as a sanitizer and/or a disinfectant, such as for agricultural equipment.

The present invention will be further clarified by the following examples, which are intended to be exemplary of the present invention.

### EXAMPLES

### Example 1

13 wt % aqueous sodium hypochlorite (NaOCl), taken as a 10 ml aliquot, was placed m a reaction vessel, and was stirred at approximately 100 rpm 5 ml of 40% aqueous sodium bromide (NaBr) was added to the NaOCl over about a 3 to 5 minute period while stirring. A gradual color change occurred as reactant NaOCl and NaBr formed HOBr. Complete formation of HOBr took about 10 to 30 minutes. At the end of the reaction, approximately 8 wt. % concentration of HOBr was generated. HOBr then underwent a pH-dependent disassociation in water to form the respective hypohalite ions. A 1:1 dilution of 2-pyrrolidone with water was prepared. 2.65 ml of a 1 to 1 (50%) concentration of 2-pyrrolidone was slowly added to the solution of HOBr over 10 to 30 minutes while stirring. An exothermic reaction took place, and care was taken to limit temperature to under 100° C. to produce approximately an 8 wt. % concentration of N-bromo-2-pyrrolidone in an aqueous solution.

### Example 2

A concentration of Example 1 was prepared (approximately 8 wt. % of N-bromo-2-pyrrolidone). An alkaline growth medium of the following composition was also prepared Cellulose 1,000 mg/l, calcium carbonate 1,000 mg/l, soluble potato starch 2,000 mg/l, monopotassium phosphate 500 mg/l, dipotassium phosphate 500 mg/l, ammonium nitrate 1,000 mg/l, magnesium sulfate 500 mg/l, and nutrient broth 500 mg/l. Therefore, the total solids volume of the makeup water was equaled to 7,000 mg/l, with a final pH of 7.4.

Enterobacter areogenes bacterium was added to the individual medium tubes to reach a final concentration of 3 2*10⁶ cells per/ml. After a standing period of 24 hours, various individual reactants and products were tested for their biocidal efficacy. The active ingredient dose was varied and after 30 minutes of contact time, the biocidal testing tubes were neutralized. The surviving cells were enumerated with alternative solid media and were allowed to grow for 24 hours as CFU/ml. From the number of surviving cells, a logarithmic reduction in the original number of introduced cells was calculated. The poor logarithmic reduction of bacterial cells in the table below showed the transient instability of HOBr prepared 24 hours earlier. In this study, while 2-pyrrolidone showed no biocidal efficacy, N-bromo-2-pyrrolidone showed excellent reduction in the log number of cells.

Log Reduction of bacteria after 30 minute
contact with biocide treatments

| | | | Log |
|---|---|---|---|
| Biocide | Dose (ppm as a. i.) | CFU/ml | Reduction |
| N-Bromo-2-pyrrolidone | 10 | <10 | 6.10 |
| HOBr | 10 | 3.2 × 10*4 | 2.15 |
| 2-pyrrolidone | 1000 | 3.3 × 10*6 | 0.00 |
| Control | 0 | 3.2 × 10*6 | 0.00 |

### Example 3

Several other biocidal moieties were prepared by reacting mixtures of methyl substituted pyrrolidone, N-vinyl substituted lactam (pyrrolidone), and polyvinylpyrrolidone with HOBr. Alkaline growth medium, as seen in Example 2, was used to test the log reduction efficacy of these preparations. An evaluation procedure similar to Example 2 was followed.

The table below indicates that these various substituted N-pyrrolidones and polymers do not effectively react to produce biocidal moieties, like the present invention. Other heterocycles, such as pyrrole, imidazole, thiazole, pyrazole, pyrrolidine, and the like, were reacted in the previously mentioned process, but none of the heterocycles tested produced a compound with biocidal efficacy. It appears that aromatic heterocycles do not produce the desired biocidal efficacy and that the only effective heterocycle moiety was the saturated, unsubstituted, keto-form e g., 2-pyrrolidone.

Log Reduction of bacteria after 30 minutes
contact with various reacted biocide compositions

| | | | Log |
|---|---|---|---|
| Biocide | Dose (ppm as a. i.) | CFU/ml | Reduction |
| N-bromo-2-pyrrolidone | 10 | <10 | 6.3 |
| Reaction of HOBr + N- | 100 | 3.6 × 10*5 | 0.7 |
| methyl pyrrolidone | | | |
| Reaction of HOBr + N- | 100 | 3.6 × 10*6 | 0.00 |
| vinyl Lactam | | | |
| Reaction of HOBr + | 100 | 3.6 × 10*6 | 0.00 |
| Polyvinylpyrrolidone | | | |
| Control | 0 | 3 6 × 10*6 | 0.00 |

### Example 4

The table below illustrates the stability of N-bromo-2-pyrrolidone as prepared in Example 1. Using the same biocidal efficacy test procedure as provided in earlier examples, the table below shows that at 10 ppm, only a 0.4 log reduction in efficacy was lost over a 16 week period.

Log Reduction of bacteria after 30 minutes contact with
N-bromo-2-pyrrolidone

| | 1 | 24 | 1 | 2 | 3 | 4 | 8 | 12 | 16 |
|---|---|---|---|---|---|---|---|---|---|
| Dose (ppm as a.i.) | hr | hr | wk | wk | wk | wk | wk | wk | wk |
| 10 | 6.1 | 6.3 | 6.2 | 6.0 | 6.05 | 6.0 | 5.9 | 5.9 | 5.7 |
| 20 | 6.15 | 6.3 | 6.4 | 6.25 | 6.2 | 6.1 | 6.0 | 6.0 | 5.9 |
| 40 | 6.2 | 6.3 | 6.4 | 6.3 | 6.25 | 6.2 | 6.0 | 6.1 | 6.1 |

Other embodiments of the present invention will be apparent to those skilled in the art from consideration of the present specification and practice of the present invention disclosed herein. It is intended that the present specification and examples be considered as exemplary only, with a true scope and spirit of the invention being indicated by the following claims and equivalents thereof

What is claimed is.

1. An aqueous solution comprising N-bromo-2-pyrrolidone.

2. The aqueous solution of claim 1, wherein said N-bromo-2-pyrrolidone is stable in said aqueous solution for at least one day.

3. The aqueous solution of claim 1, further comprising hypobromous acid.

4. A composition comprising a reaction of a hypobromous acid with a 2-pyrrolidone.

5. The composition of claim 4, wherein said hypobromous acid and said 2-pyrrolidone have a wt. ratio of from about 1:1 to about 1:2.

6. The composition of claim 4, wherein said hypobromous acid forms from reacting at least one oxidizing agent with at least one bromide source.

7. The composition of claim 6, wherein said oxidizing agent is sodium hypochlorite.

8. The composition of claim 6, wherein said oxidizing agent has a concentration of from about 2 wt. % to about 30 wt. % based on the weight of sodium hypochlorite.

9. The composition of claim 6, wherein said bromide source is sodium bromide.

10. The composition of claim 6, further comprising a solvent capable of dissolving said bromide source.

11. The composition of claim 6, wherein said bromide source has a concentration of from about 20 wt. % to about 60 wt. %.

12. The composition of claim 6, wherein said oxidizing agent and said bromide source have a wt. ratio of from about 1:4 to about 1:2.

13. The composition of claim 6, wherein said oxidizing agent is diluted in water in an oxidizing agent-to-water wt. ratio of from about 1:7.5 to about 1:3.5.

14. The composition of claim 6, wherein said bromide source is diluted in water in a bromide source-to-water wt. ratio of about from about 1:5 to about 3:5

15. The composition of claim 3, wherein said 2-pyrrolidone is diluted in water in a 2-pyrrolidone-to-water wt. ratio of from about 1:100 to about 100:1.

16. A method of making an N-bromo-2-pyrrolidone comprising reacting a hypobromous acid with a 2-pyrrolidone.

17. The method of claim 16, wherein said hypobromous acid and said 2-pyrrolidone are in a wt. ratio of from about 1:1 to about 1:2.

18. The method of claim 16, wherein said hypobromous acid is formed by reacting at least one oxidizing agent with at least one bromide source.

19. The method of claim 18, wherein said oxidizing agent is sodium hypochlorite.

20. The method of claim 18, wherein said oxidizing agent has a concentration of from about 2 wt. % to about 30 wt. %, and said bromide source has a concentration of from about 20 wt. % to about 60 wt. %.

21. The method of claim 18, wherein said bromide source is sodium bromide.

22. The method of claim 18, further comprising dissolving said bromide source in a solvent.

23. The method of claim 18, wherein said oxidizing agent and said bromide source have a wt. ratio of from about 1:2.5 to about 1:3.2.

24. The method of claim 20, wherein said oxidizing agent is diluted in water in an oxidizing agent-to-water wt. ratio of from about 1:7.5 to about 1:3.5.

25. The method of claim 20, wherein said bromide source is diluted in water in a bromide source-to-water wt. ratio of from about 1:5 to about 3:5.

26. The method of claim 16, wherein said 2-pyrrolidone is prepared by diluting said 2-pyrrolidone in water at a 2-pyrrolidone-to-water wt. ratio of from about 10:1 to about 1:10.

27. The method of claim 16, wherein said method is conducted at a temperature of 100° C. or below.

28. A method to provide a single-line feed biocidal program for a water system with organic demand comprising introducing the composition of claim 1 to said water system.

29. A method to inhibit the growth of living organisms in an aqueous system having high chlorine demand comprising introducing the composition of claim 1 to said aqueous system.

30. A method to provide a clear, colorless, liquid concentrate which does not taint or color processed water comprising contacting the composition of claim 1 to said processed water.

31. A method to sanitize and disinfect hard surfaces comprising contacting the composition of claim 1 to said hard surfaces.

32. A method to prevent biofouling in an aqueous system having high chlorine demand comprising introducing the composition of claim 1 to said aqueous system.

33. The aqueous solution of claim 1, wherein said N-bromo-2-pyrrolidone is stable for at least one week.

34. The aqueous solution of claim 1, wherein said N-bromo-2-pyrrolidone is stable for at least 6 months.

35. The aqueous solution of claim 1, wherein said N-bromo-2-pyrrolidone is stable for at least one year.
